(19) United States
(12) Patent Application Publication
(10) Pub. No.: US 2021/0349621 A1
(43) Pub. Date: Nov. 11, 2021

(54) SETTING APPARATUS, COMPUTER-READABLE NON-TRANSITORY RECORDING MEDIUM STORING SETTING PROGRAM, ELECTRONIC APPARATUS, COMPUTER-READABLE NON-TRANSITORY RECORDING MEDIUM STORING OPERATION SCREEN CONTROL PROGRAM, AND INFORMATION PROCESSING SYSTEM

(71) Applicant: KYOCERA Document Solutions Inc., Osaka-shi (JP)

(72) Inventor: Masato HIROTA, Osaka-shi (JP)

(21) Appl. No.: 17/241,406

(22) Filed: Apr. 27, 2021

(30) Foreign Application Priority Data
May 8, 2020 (JP) 2020-082494

(51) Int. Cl. G06F 3/0484; G06F 3/12

(52) U.S. Cl. CPC G06F 3/04847; G06F 3/1258; G06F 3/1232; G06F 3/1204

(57) ABSTRACT

A setting apparatus, which sets an operation screen of an image forming apparatus, acquires, from a plurality of image forming apparatuses, a setting item whose setting value is specifiable with regard to a function corresponding to a setting-value specified button included in the operation screen and displays a setting item acquired from at least one of the image forming apparatuses on a setting value specifying screen for specifying a setting value for the setting-value specified button.

### INCORPORATION BY REFERENCE

This application is based upon, and claims the benefit of priority from, corresponding Japanese Patent Application No. 2020-082494 filed in the Japan Patent Office on May 8, 2020, the entire contents of which are incorporated herein by reference.

### BACKGROUND

### Field of the Invention

The present disclosure relates to a setting apparatus that sets an operation screen of an electronic apparatus, a computer-readable non-transitory recording medium storing a setting program, an electronic apparatus, a computer-readable non-transitory recording medium storing an operation screen control program, and an information processing system.

### Description of Related Art

Typically, there is a known electronic apparatus that displays an operation screen including a setting-value specified button to execute the function in accordance with a previously specified setting value.

### SUMMARY

A setting apparatus according to the present disclosure sets an operation screen of an electronic apparatus, wherein the operation screen includes a setting-value specified button to execute a function in accordance with a previously specified setting value, and the setting apparatus acquires, from the electronic apparatuses, a setting item whose setting value is specifiable with regard to a function corresponding to the setting-value specified button and displays a setting item acquired from at least one of the electronic apparatuses on a setting value specifying screen for specifying a setting value for the setting-value specified button.

A computer-readable non-transitory recording medium according to the present disclosure stores a setting program, and the setting program is executed by a setting apparatus that sets an operation screen of an electronic apparatus. The operation screen includes a setting-value specified button to execute a function in accordance with a previously specified setting value, and the setting program causes the setting apparatus to acquire, from the electronic apparatuses, a setting item whose setting value is specifiable with regard to a function corresponding to the setting-value specified button and causes the setting apparatus to display a setting item acquired by the setting apparatus from at least one of the electronic apparatuses on a setting value specifying screen for specifying a setting value for the setting-value specified button.

An electronic apparatus according to the present disclosure displays an operation screen, wherein the operation screen includes a setting-value specified button to execute a function in accordance with a previously specified setting value, and the electronic apparatus exclusively displays, on a setting value receiving screen for receiving an instruction to change a setting value of a setting item associated with the setting-value specified button, a setting item supported by the electronic apparatus among setting items included in the operation screen received from a setting apparatus that sets the operation screen.

A computer-readable non-transitory recording medium according to the present disclosure stores an operation screen control program, and the operation screen control program is executed by an electronic apparatus that displays an operation screen. The operation screen includes a setting-value specified button to execute a function in accordance with a previously specified setting value, and the operation screen control program causes the electronic apparatus to exclusively display, on a setting value receiving screen for receiving an instruction to change a setting value of a setting item associated with the setting-value specified button, a setting item supported by the electronic apparatus among setting items included in the operation screen received by the electronic apparatus from a setting apparatus that sets the operation screen.

An electronic apparatus according to the present disclosure displays an operation screen, wherein the operation screen includes a setting-value specified button to execute a function in accordance with a previously specified setting value, and when the electronic apparatus does not support a setting value specified for a setting item included in the operation screen received from a setting apparatus that sets the operation screen, the electronic apparatus changes the setting value to a default setting value of the electronic apparatus.

A computer-readable non-transitory recording medium according to the present disclosure stores an operation screen control program, and the operation screen control program is executed by an electronic apparatus that displays an operation screen. The operation screen includes a setting-value specified button to execute a function in accordance with a previously specified setting value, and when the electronic apparatus does not support a setting value specified for a setting item included in the operation screen received by the electronic apparatus from a setting apparatus that sets the operation screen, the operation screen control program causes the electronic apparatus to change the setting value to a default setting value of the electronic apparatus.

An information processing system according to the present disclosure includes: an electronic apparatus that displays an operation screen; and a setting apparatus that sets the operation screen, wherein the operation screen includes a setting-value specified button to execute a function in accordance with a previously specified setting value, and the setting apparatus acquires, from the electronic apparatuses, a setting item whose setting value is specifiable with regard to a function corresponding to the setting-value specified button and displays a setting item acquired from at least one of the electronic apparatuses on a setting value specifying screen for specifying a setting value for the setting-value specified button.

### BRIEF DESCRIPTION OF THE DRAWINGS

FIG. 1 is a block diagram of an information processing system according to an embodiment of the present disclosure;

FIG. 2 is a block diagram of an image forming apparatus illustrated in FIG. 1 when the image forming apparatus is configured as an MFP;

FIG. 3 is a diagram illustrating an example of an operation screen displayed on a display unit illustrated in FIG. 2 based on operation screen information;

FIG. 4 is an example of a table indicating whether setting items of a “copy” function of the image forming apparatuses that may be included in the information processing system illustrated in FIG. 1 are common to all the image forming apparatuses;

FIG. 5 is a block diagram of a user terminal illustrated in FIG. 1;

FIG. 6 is a flowchart of the operation of the user terminal illustrated in FIG. 5 to edit the operation screen of the image forming apparatus;

FIG. 7 is a table illustrating an example of setting items included in a setting value specifying screen displayed during the operation illustrated in FIG. 6;

FIG. 8 is a diagram illustrating an example of a setting value specifying screen displayed during the operation illustrated in FIG. 6;

FIG. 9 is a flowchart of the operation of the image forming apparatus illustrated in FIG. 2 when various types of information on the operation screen are received from the user terminal;

FIG. 10 is a flowchart of the operation of the image forming apparatus illustrated in FIG. 2 when a setting-value specified button is pressed on the operation screen; and

FIG. 11 is a diagram illustrating an example of a setting value receiving screen displayed during the operation illustrated in FIG. 10.

### DETAILED DESCRIPTION

An embodiment of the present disclosure is described below with reference to the drawings.

First, a configuration of an information processing system according to an embodiment of the present disclosure is described.

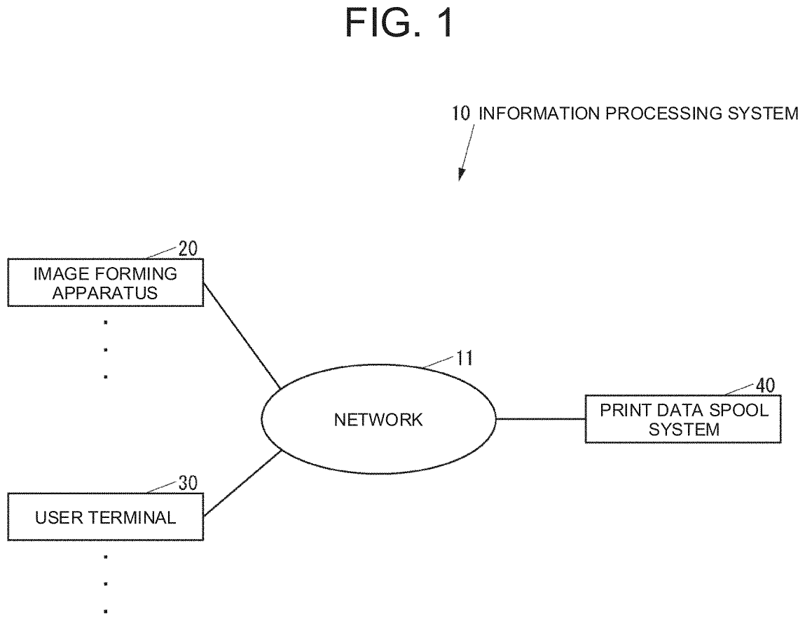

FIG. 1 is a block diagram of an information processing system 10 according to the present embodiment.

As illustrated in FIG. 1, the information processing system 10 includes an image forming apparatus 20 that is an electronic apparatus. In addition to the image forming apparatus 20, the information processing system 10 may include at least one image forming apparatus having the same configuration as that of the image forming apparatus 20. The image forming apparatus in the information processing system 10 includes, for example, a multifunction peripheral (MFP) or a dedicated printer.

The information processing system 10 includes a user terminal 30 used by a user. The user terminal 30 may set an operation screen of the image forming apparatus and includes a setting apparatus according to the present disclosure. In addition to the user terminal 30, the information processing system 10 may include at least one user terminal having the same configuration as that of the user terminal 30. The user terminal in the information processing system 10 includes, for example, a computer such as a personal computer (PC).

The information processing system 10 may include, for example, a print data spool system 40 that spools print data transmitted from the user terminal. The print data spool system 40 may be configured by using one computer or may be configured by using a plurality of computers. The print data spool system 40 may output the spooled print data to any of the image forming apparatuses.

The image forming apparatus in the information processing system 10, the user terminal in the information processing system 10, and the print data spool system 40 may be communicably connected to each other via a network 11 such as a local area network (LAN).

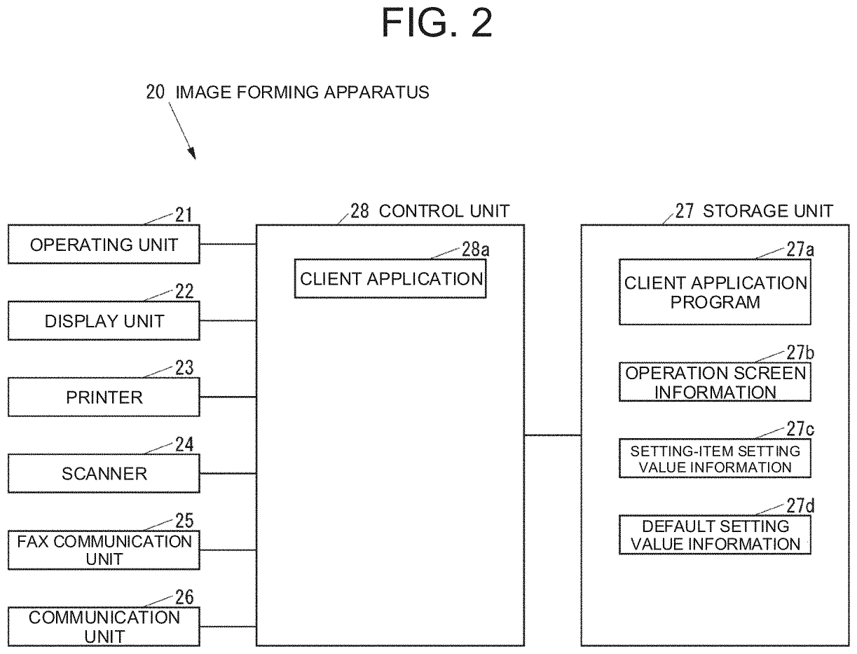

FIG. 2 is a block diagram of the image forming apparatus 20 when the image forming apparatus 20 is configured as an MFP.

As illustrated in FIG. 2, the image forming apparatus 20 is a computer that includes: an operating unit 21 that is an input device such as a button to which various operations are input; a display unit 22 that is a display device such as a liquid crystal display (LCD) that displays various types of information; a printer 23 that is a printing device that prints an image on a recording medium such as paper; a scanner 24 that is a scan device that scans an image from a document; a fax communication unit 25 that is a fax device that performs fax communications with an external fax device (not illustrated) via a communication line such as a public telephone line; a communication unit 26 that is a communication device that performs communications with an external device via a network such as a LAN or the Internet or directly by wire or wirelessly without a network; a storage unit 27 that is a non-volatile storage device such as a semiconductor memory or a hard disk drive (HDD) that stores various types of information; and a control unit 28 that controls the overall image forming apparatus 20.

The image forming apparatus 20 may perform functions such as “scan” to scan an image from a document by the scanner 24, “print” to print, on a recording medium by the printer 23, various images such as an image based on print data received via the communication unit 26, “copy” to print the image scanned by the scanner 24 from a document on a recording medium by the printer 23, “fax transmission” to transmit the image scanned by the scanner 24 from a document by fax communication by the fax communication unit 25, and “scan transmission” to transmit, by the communication unit 26, the image scanned from a document by the scanner 24.

The storage unit 27 may store a client application program 27a that is an application program for providing the user with a function of the image forming apparatus 20 and the print data spool system 40 (see FIG. 1). The client application program 27a may be installed in the image forming apparatus 20, for example, at the manufacturing stage of the image forming apparatus 20, may be additionally installed in the image forming apparatus 20 from an external storage medium such as a Universal Serial Bus (USB) memory, or may be additionally installed in the image forming apparatus 20 via a network. The client application program 27a is a program that may control an operation screen of the image forming apparatus 20 and includes an operation screen control program according to the present disclosure.

The storage unit 27 may store operation screen information 27b indicating various types of information on an operation screen of the image forming apparatus 20.

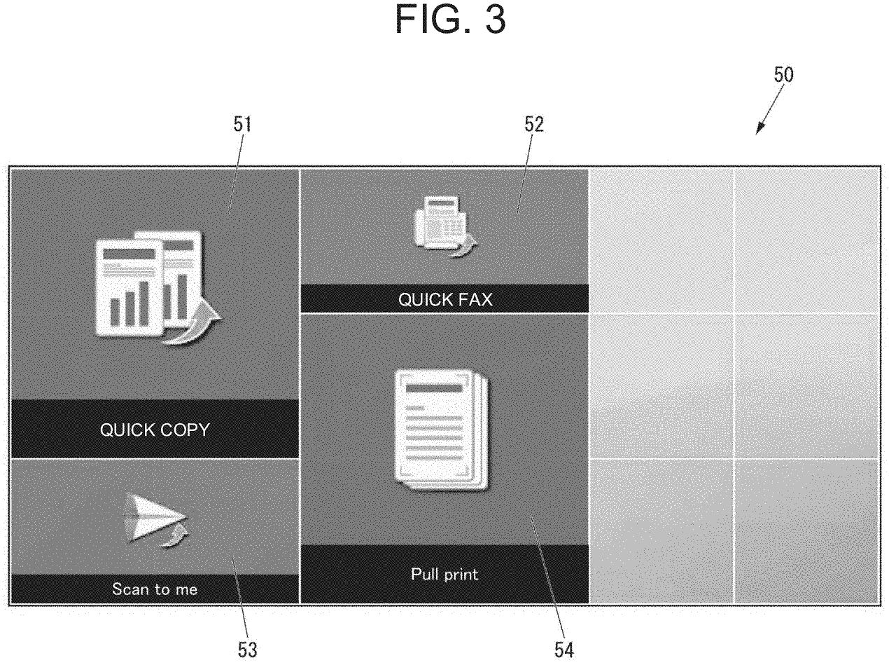

FIG. 3 is a diagram illustrating an example of an operation screen 50 displayed on the display unit 22 based on the operation screen information 27b.

The operation screen 50 illustrated in FIG. 3 includes a “quick copy” button 51 for executing copying with the settings corresponding to previously specified values, a “quick fax” button 52 for executing fax transmission with the settings corresponding to previously specified values, a “scan to me” button 53 for transmitting an image scanned from a document by the scanner 24 to a specific e-mail address, and a “Pull print” button 54 for executing printing with the printer 23 based on print data spooled in the print data spool system 40.

Here, the “quick copy” button 51 and the “quick fax” button 52 are buttons (hereinafter referred to as “setting-value specified buttons”) for executing a function corresponding to previously specified setting values. A setting-value specified button other than the “quick copy” button and the “quick fax” button may be provided on the operation screen 50. As a setting-value specified button, for example, there are a “quick scan” button for executing scan with the settings corresponding to previously specified values and a “quick print” button for executing printing with the settings corresponding to previously specified values.

The operation screen 50 may include a plurality of setting-value specified buttons for the identical function of the image forming apparatus 20. Therefore, the operation screen 50 may include a plurality of setting-value specified buttons for the identical function of the image forming apparatus 20 depending on the purpose. For example, the operation screen 50 may include a “quick copy” button for invoice in which the setting value suitable for copying an invoice is specified and a “quick copy” button for photograph in which the setting value suitable for copying a photograph is specified.

As illustrated in FIG. 2, the storage unit 27 stores, for each of various functions of the image forming apparatus 20, setting-item setting value information 27c indicating a setting item for which a setting value is specifiable and a setting value that is specifiable for the setting item.

The storage unit 27 stores default setting value information 27d indicating the default setting value for each of various setting items of various functions of the image forming apparatus 20.

The control unit 28 includes, for example, a central processing unit (CPU), a read only memory (ROM) that stores a program and various types of data, and a random access memory (RAM) that is a volatile storage device memory used as a work area of the CPU of the control unit 28. The CPU of the control unit 28 executes a program stored in the storage unit 27 or the ROM of the control unit 28.

The control unit 28 executes the client application program 27a to implement a client application 28a.

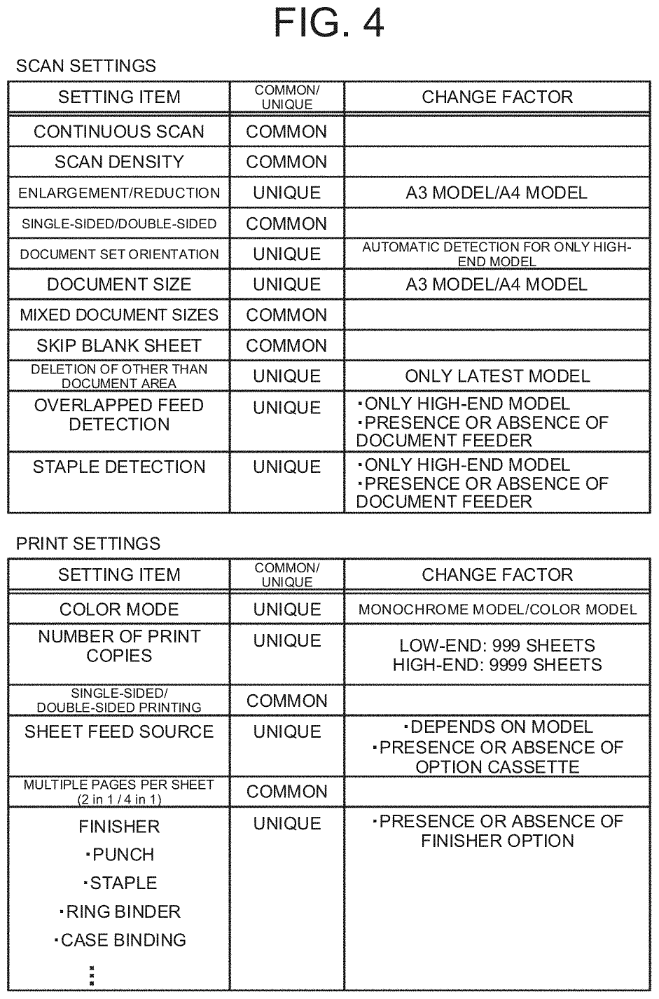

The image forming apparatuses that may be included in the information processing system 10 may be different in a setting item for which a setting value is specifiable and a setting value that is specifiable for the setting item with regard to various functions of the image forming apparatus for various reasons, such as a difference in the release time of the image forming apparatus or a difference in the model of the image forming apparatus such as a high-end model and a low-end model. For example, FIG. 4 indicates whether the setting items of the “copy” function of the image forming apparatuses that may be included in the information processing system 10 are common to all the image forming apparatuses.

FIG. 4 is an example of the table indicating whether the setting items of the “copy” function of the image forming apparatuses that may be included in the information processing system 10 are common to all the image forming apparatuses.

The “copy” function is performed by the combination of the “scan” function and the “print” function. Therefore, as illustrated in FIG. 4, the setting items of the “copy” function include the setting items of the “scan” function and the setting items of the “print” function.

In the example illustrated in FIG. 4, the setting items of the “scan” function include “continuous scan” for the setting whether to continuously scan images from documents by the scanner, “scan density” for the setting of the scan density of an image by the scanner, “enlargement/reduction” for the setting of the rate at which the size of the image scanned by the scanner is enlarged or reduced, “single-sided/double-sided” for the setting whether to scan an image by the scanner from only one side of a document or scan images by the scanner from both sides of a document, “document set orientation” for the setting whether to automatically detect the orientation of the document set in the image forming apparatus, “document size” for the setting of the size of the document whose image is scanned by the scanner, “mixed document sizes” for the setting whether to scan multiple documents including documents with different sizes by the scanner, “skip blank sheet” for the setting whether no image is scanned from a blank document by the scanner, “deletion of other than the document area” for the setting whether to print in white the part other than a document area in the image scanned by the scanner, “overlapped feed detection” for the setting whether to detect that the documents are conveyed in an overlapped manner by the scanner, and “staple detection” for the setting whether to detect that a document has been stapled.

In the example illustrated in FIG. 4, “continuous scan”, “scan density”, “single-sided/double-sided”, “mixed document sizes”, and “skip blank sheet” are the setting items present in all the image forming apparatuses that may be included in the information processing system 10, and specifiable setting values are also identical in all the image forming apparatuses that may be included in the information processing system 10. Therefore, in the example illustrated in FIG. 4, “continuous scan”, “scan density”, “single-sided/double-sided”, “mixed document sizes”, and “skip blank sheet” are indicated, in the “common/unique” column, as “common” indicating a setting item common to all the image forming apparatuses that may be included in the information processing system 10.

In the example illustrated in FIG. 4, although “enlargement/reduction” and “document size” are setting items present in all the image forming apparatuses that may be included in the information processing system 10, specifiable setting values are different, as indicated in the “change factor” column, depending on whether the image forming apparatus is of an A3 model whose maximum size of a document of an image scannable by the scanner is an A3 size or whether the image forming apparatus is of an A4 model whose maximum size of a document of an image scannable by the scanner is an A4 size. Therefore, in the example illustrated in FIG. 4, “enlargement/reduction” and “document size” are indicated, in the “common/unique” column, as “unique” indicating not the setting item common to all the image forming apparatuses that may be included in the information processing system 10.

In the example illustrated in FIG. 4, “document set orientation” is a setting item present only in the high-end model image forming apparatus as only the high-end model image forming apparatus may automatically detect the orientation of the document set in the image forming apparatus as indicated in the “change factor” column. Therefore, in the example illustrated in FIG. 4, “document set orientation” is indicated as “unique” in the “common/unique” column.

In the example illustrated in FIG. 4, “deletion of other than the document area” is a setting item only for the latest model image forming apparatus, as indicated in the “change factor” column. Therefore, “deletion of other than the document area” is indicated as “unique” in the “common/unique” column in the example illustrated in FIG. 4.

In the example illustrated in FIG. 4, “overlapped feed detection” and “staple detection” are setting items only for the high-end model image forming apparatus as indicated in the “change factor” column and are setting items whose setting values are not specifiable even by the high-end model image forming apparatus when the scanner does not include a document feeder that automatically conveys a plurality of documents to a read unit. Therefore, “overlapped feed detection” and “staple detection” are indicated as “unique” in the “common/unique” column in the example illustrated in FIG. 4.

In the example illustrated in FIG. 4, the setting items of the “print” function include “color mode” for the setting whether to execute either monochrome printing or color printing, “number of print copies” for the setting of the number of print copies, “single-sided/double-sided printing” for the setting whether to execute either single-sided printing or double-sided printing, “sheet feed source” for the setting of any one of the sheet feed sources in the image forming apparatus to feed a sheet, “multiple pages per sheet (2 in ¼ in 1)” for the setting whether to print images of multiple pages on one page, i.e., to print images of two pages on one page or to print images of four pages on one page, “punch” to punch a printed sheet, “staple” to staple a printed sheet, “ring binder” to punch a printed sheet and insert a ring binder into a hole, and “finisher” for the setting whether to execute specific post-processing on a printed sheet, such as “case binding” to execute case binding on printed sheets.

In the example illustrated in FIG. 4, “single-sided/double-sided printing” and “multiple pages per sheet (2 in ¼ in 1)” are setting items present in all the image forming apparatuses that may be included in the information processing system 10, and specifiable setting values are also identical in all the image forming apparatuses that may be included in the information processing system 10. Therefore, “single-sided/double-sided printing” and “multiple pages per sheet (2 in ¼ in 1)” are indicated as “common” in the “common/unique” column in the example illustrated in FIG. 4.

In the example illustrated in FIG. 4, “color mode” is a setting item only for the color model image forming apparatus and, as indicated in the “change factor” column, the setting item is settable or not depending on whether the image forming apparatus is a monochrome model or a color model. Therefore, “color mode” is indicated as “unique” in the “common/unique” column in the example illustrated in FIG. 4.

In the example illustrated in FIG. 4, “number of print copies” is a setting item present in all the image forming apparatuses that may be included in the information processing system 10; however, as indicated in the “change factor” column, the setting value of the low-end model image forming apparatus may be specified up to 999 sheets, while the setting value of the high-end model image forming apparatus may be specified up to 9999 sheets. Therefore, “number of print copies” is indicated as “unique” in the “common/unique” column in the example illustrated in FIG. 4.

In the example illustrated in FIG. 4, “sheet feed source” is a setting item present in all the image forming apparatuses that may be included in the information processing system 10; however, as indicated in the “change factor” column, a specifiable setting value is different depending on the model of the image forming apparatus as the number of sheet feed cassettes, which are the sheet feed sources in the image forming apparatus, is different depending on the model of the image forming apparatus and also a specifiable setting value is different depending on whether an optional sheet feed cassette is coupled to the image forming apparatus even if the image forming apparatus is of the identical model. Therefore, “sheet feed source” is indicated as “unique” in the “common/unique” column in the example illustrated in FIG. 4.

In the example illustrated in FIG. 4, with regard to “finisher”, a specifiable setting value is different depending on whether any finisher option is coupled to the image forming apparatus to perform specific post-processing on a printed sheet, as indicated in the “change factor” column. Therefore, “finisher” is indicated as “unique” in the “common/unique” column in the example illustrated in FIG. 4.

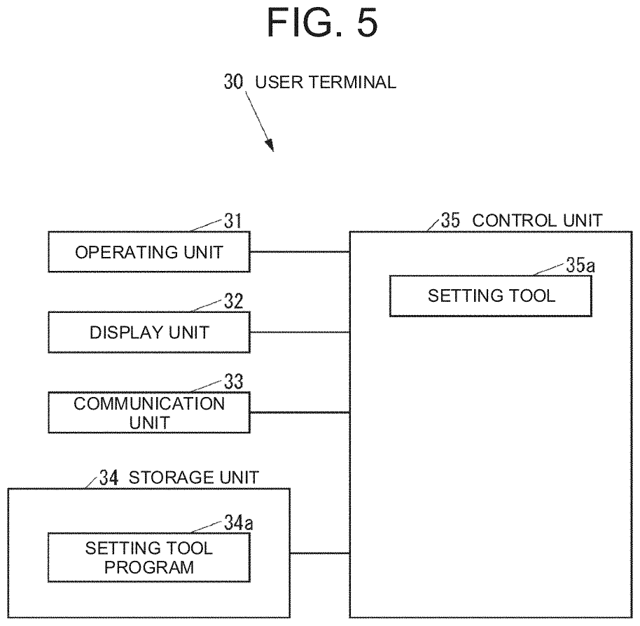

FIG. 5 is a block diagram of the user terminal 30.

As illustrated in FIG. 5, the user terminal 30 includes: an operating unit 31 that is an operating device such as a keyboard and a mouse with which various operations are input; a display unit 32 that is a display device such as an LCD to display various types of information; a communication unit 33 that is a communication device that communicates with an external device via a network such as a LAN or the Internet or directly by wire or wirelessly without a network; a storage unit 34 that is a non-volatile storage device such as a semiconductor memory or an HDD that stores various types of information; and a control unit 35 that controls the overall user terminal 30.

The storage unit 34 stores a setting tool program 34a as a setting program for setting the client application program 27a (see FIG. 2). The setting tool program 34a may be installed in the user terminal 30, for example, at the manufacturing stage of the user terminal 30, may be additionally installed in the user terminal 30 from an external storage medium such as a compact disk (CD), a digital versatile disk (DVD), or a USB memory, or may be additionally installed in the user terminal 30 via a network.

The control unit 35 includes, for example, a CPU, a ROM that stores a program and various types of data, and a RAM that is a volatile storage device used as a work area of the CPU of the control unit 35. The CPU of the control unit 35 executes a program stored in the storage unit 34 or the ROM of the control unit 35.

The control unit 35 executes the setting tool program 34a to implement a setting tool 35a. The setting tool 35a may install the client application program in the image forming apparatus.

The setting tool 35a stores, for each of various functions of the image forming apparatus in the information processing system 10, all the setting items whose setting values are specifiable in at least one image forming apparatus in the information processing system 10 and the setting values that are specifiable for the setting items in at least one image forming apparatus in the information processing system 10.

Next, an operation of the information processing system 10 is described.

First, the operation of the user terminal 30 to search for an image forming apparatus on the network is described.

When the instruction to add an image forming apparatus is given via the operating unit 31, the setting tool 35a of the user terminal 30 searches for the image forming apparatus on the network and acquires, from the image forming apparatus, the information for identifying the image forming apparatus, such as the host name, the model name, the manufacturing number, etc., of the image forming apparatus.

Next, the operation of the user terminal 30 to edit an operation screen of the image forming apparatus is described.

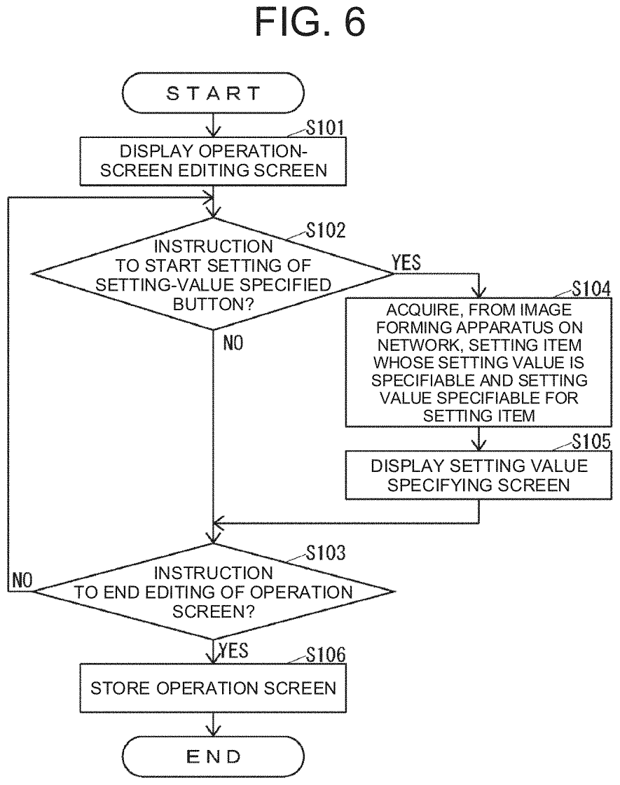

FIG. 6 is a flowchart of the operation of the user terminal 30 to edit the operation screen of the image forming apparatus.

When the instruction to start the editing of the operation screen of the image forming apparatus is given via the operating unit 31, the setting tool 35a of the user terminal 30 performs the operation illustrated in FIG. 6.

As illustrated in FIG. 6, the setting tool 35a causes the display unit 32 to display an operation-screen editing screen to edit the operation screen of the image forming apparatus (S101). The buttons for causing the image forming apparatus to execute various operations may be provided on the operation screen of the operation-screen editing screen in response to the instruction via the operating unit 31.

After the process at S101, the setting tool 35a determines whether the instruction to start the setting of a setting-value specified button provided on the operation screen of the operation-screen editing screen has been given via the operating unit 31 (S102).

When it is determined at S102 that the instruction to start the setting of the setting-value specified button provided on the operation screen of the operation-screen editing screen has not been given via the operating unit 31, the setting tool 35a determines whether the instruction to end the editing of the operation screen has been given via the operating unit 31 (S103).

When it is determined at S103 that the instruction to end the editing of the operation screen has not been given via the operating unit 31, the setting tool 35a executes the process at S102.

When it is determined at S102 that the instruction to start the setting of the setting-value specified button provided on the operation screen of the operation-screen editing screen has been given via the operating unit 31, the setting tool 35a uses the previously acquired information for identifying an image forming apparatus to acquire, from the image forming apparatus on the network, a setting item whose setting value is specifiable and a setting value that is specifiable for the setting item with regard to a function corresponding to the setting-value specified button (S104). Here, the image forming apparatus uses the setting-item setting value information to respond to the information acquisition request from the user terminal 30.

Subsequently, the setting tool 35a causes a setting value specifying screen for specifying a setting value for the setting-value specified button to be displayed based on the information acquired at S104 (S105). Here, the setting tool 35a causes a setting item acquired from at least one image forming apparatus at S104 to be displayed on the setting value specifying screen as a setting item whose setting value is specifiable. Furthermore, the setting tool 35a causes a setting value acquired from at least one image forming apparatus for the setting item at S104 to be displayed on the setting value specifying screen as a setting value that is specifiable for the setting item.

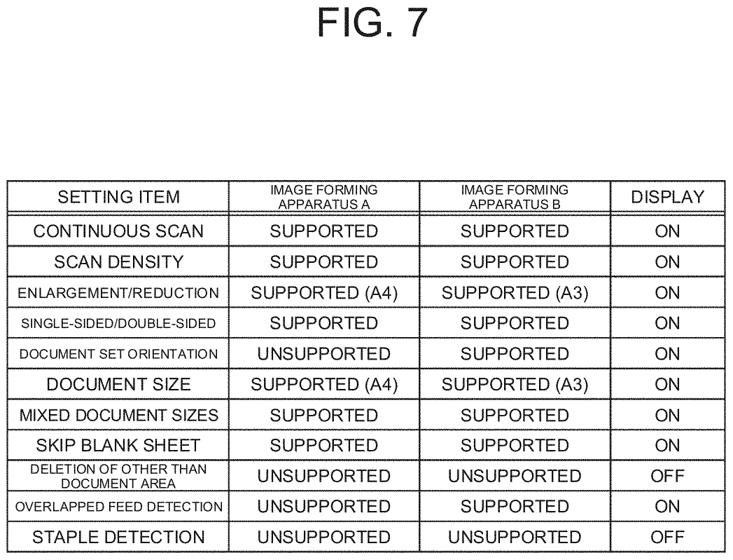

FIG. 7 is a table illustrating an example of setting items included in the setting value specifying screen displayed at S105.

When information is acquired from an image forming apparatus A and an image forming apparatus B at S104 and the setting items of the “scan” function are displayed at S105, the setting items displayed at S105 are as illustrated in for example FIG. 7. Here, the image forming apparatus A is an image forming apparatus of an A4 model, and the image forming apparatus B is an image forming apparatus of an A3 model.

As illustrated in FIG. 7, with regard to the image forming apparatus A, “continuous scan”, “scan density”, “single-sided/double-sided”, “mixed document sizes”, and “skip blank sheet”, which are the “common” setting items in FIG. 4, and “enlargement/reduction” and “document size” among the “unique” setting items in FIG. 4 are supported, and “document set orientation”, “deletion of other than the document area”, “overlapped feed detection”, and “staple detection” are not supported.

As illustrated in FIG. 7, with regard to the image forming apparatus B, “continuous scan”, “scan density”, “single-sided/double-sided”, “mixed document sizes”, and “skip blank sheet”, which are the “common” setting items in FIG. 4, and “enlargement/reduction”, “document set orientation”, “document size”, and “overlapped feed detection” among the “unique” setting items in FIG. 4 are supported, and “deletion of other than the document area” and “staple detection” are not supported.

Therefore, at S105, “continuous scan”, “scan density”, “enlargement/reduction”, “single-sided/double-sided”, “document set orientation”, “document size”, “mixed document sizes”, “skip blank sheet”, and “overlapped feed detection” supported by at least either the image forming apparatus A or the image forming apparatus B are displayed, and “deletion of other than the document area” and “staple detection” supported by neither the image forming apparatus A nor the image forming apparatus B are not displayed.

As “continuous scan”, “scan density”, “single-sided/double-sided”, “mixed document sizes”, and “skip blank sheet”, which are the “common” setting items in FIG. 4, are supported by both the image forming apparatus A and the image forming apparatus B, all the setting values are displayed. As “enlargement/reduction” and “document size”, which are the “unique” setting items in FIG. 4, are supported by both the image forming apparatus A and the image forming apparatus B, the setting value supported by at least either the image forming apparatus A or the image forming apparatus B is displayed. As “document set orientation” and “overlapped feed detection”, which are the “unique” setting items in FIG. 4, are supported only by the image forming apparatus B, only the setting value supported by the image forming apparatus B is displayed.

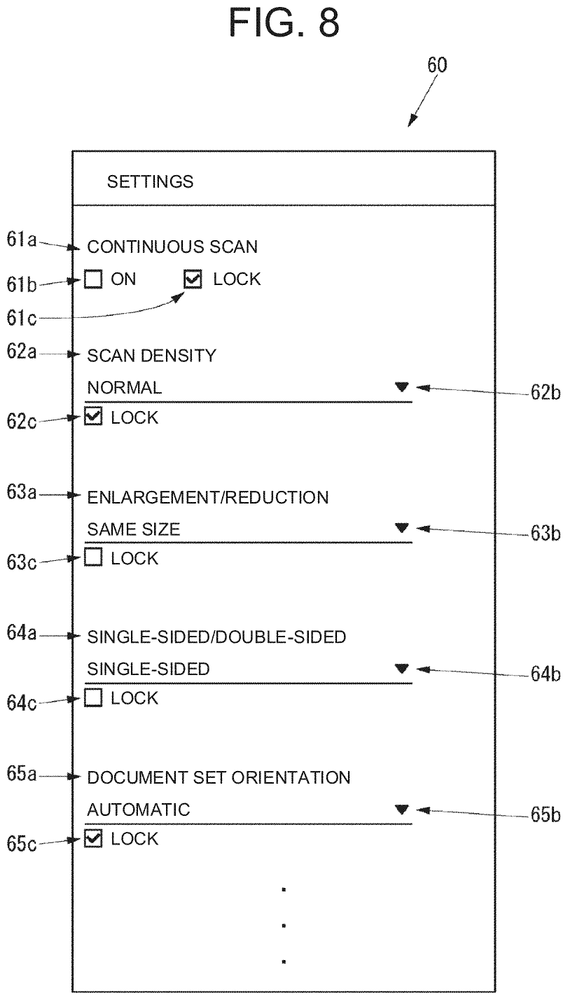

FIG. 8 is a diagram illustrating an example of a setting value specifying screen 60 displayed at S105.

The setting value specifying screen 60 illustrated in FIG. 8 is a screen for specifying the setting values for the setting-value specified button corresponding to the “scan” function.

The setting value specifying screen 60 includes a text 61a representing the setting item “continuous scan”, a check box 61b for specifying the setting value for the setting item “continuous scan”, and a check box 61c for specifying either the lock state indicating that the setting value for the setting item “continuous scan” is not changeable via the operating unit of the image forming apparatus or the unlock state indicating that the setting value is changeable via the operating unit of the image forming apparatus.

The setting value specifying screen 60 includes a text 62a representing the setting item “scan density”, a drop-down list 62b for specifying the setting value of the setting item “scan density”, and a check box 62c for specifying either the lock state or the unlock state for the setting item “scan density”.

The setting value specifying screen 60 includes a text 63a representing the setting item “enlargement/reduction”, a drop-down list 63b for specifying the setting value of the setting item “enlargement/reduction”, and a check box 63c for specifying either the lock state or the unlock state for the setting item “enlargement/reduction”.

The setting value specifying screen 60 includes a text 64a representing the setting item “single-sided/double-sided”, a drop-down list 64b for specifying the setting value of the setting item “single-sided/double-sided”, and a check box 64c for specifying either the lock state or the unlock state for the setting item “single-sided/double-sided”.

The setting value specifying screen 60 includes a text 65a representing the setting item “document set orientation”, a drop-down list 65b for specifying the setting value of the setting item “document set orientation”, and a check box 65c for specifying either the lock state or the unlock state for the setting item “document set orientation”.

Although not illustrated in FIG. 8, the setting tool 35a designates the order of display, on the image forming apparatus, of the setting items in the unlock state on the setting value specifying screen 60.

As illustrated in FIG. 6, the setting tool 35a executes the process at S103 after the process at S105.

When it is determined at S103 that the instruction to end the editing of the operation screen has been given via the operating unit 31, the setting tool 35a stores the operation screen set on the operation-screen editing screen (S106). Here, when the operation screen set on the operation-screen editing screen includes a setting-value specified button, a setting item set for the setting-value specified button, the setting value for the setting item, the information on either the lock state or the unlock state specified for the setting item, and the display order designated for the setting items in the unlock state are stored as partial information on the operation screen.

The setting tool 35a ends the operation illustrated in FIG. 6 after the process at S106.

When an instruction has been given via the operating unit 31 to transmit various types of information on the operation screen stored at S106 to an image forming apparatus, the setting tool 35a transmits various types of information on the operation screen stored at S106 to all the image forming apparatuses for which the information has been acquired at S104.

Next, the operation of the image forming apparatus 20 when various types of information on the operation screen are received from the user terminal 30 is described.

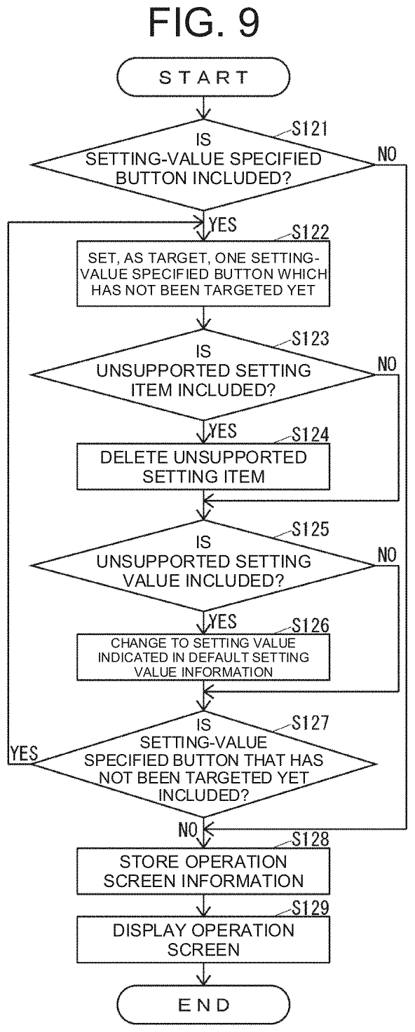

FIG. 9 is a flowchart of the operation of the image forming apparatus 20 when various types of information on the operation screen are received from the user terminal 30.

When various types of information on the operation screen are received from the user terminal 30, the client application 28a of the image forming apparatus 20 executes the operation illustrated in FIG. 9.

As illustrated in FIG. 9, the client application 28a determines whether the operation screen received from the user terminal 30 includes a setting-value specified button (S121).

When it is determined at S121 that the operation screen received from the user terminal 30 includes setting-value specified buttons, the client application 28a sets, as a target, only one setting-value specified button, which has not been targeted yet among the setting-value specified buttons included in the operation screen received from the user terminal 30 (S122).

Subsequently, the client application 28a determines, based on the setting-item setting value information 27c, whether the setting items set for the currently targeted setting-value specified button include a setting item not supported by the image forming apparatus 20 (S123).

When it is determined at S123 that the setting items set for the currently targeted setting-value specified button include a setting item not supported by the image forming apparatus 20, the client application 28a deletes the setting item not supported by the image forming apparatus 20 from the setting items set for the currently targeted setting-value specified button (S124).

When it is determined at S123 that the setting items set for the currently targeted setting-value specified button do not include a setting item not supported by the image forming apparatus 20 or the process at S124 ends, it is determined, based on the setting-item setting value information 27c, whether the setting values set for the setting items set for the currently targeted setting-value specified button include a setting value not supported by the image forming apparatus 20 (S125).

When it is determined at S125 that the setting values set for the setting items set for the currently targeted setting-value specified button include a setting value not supported by the image forming apparatus 20, the client application 28a changes the setting value set for the setting item set for the currently targeted setting-value specified button to the setting value indicated in the default setting value information 27d (S126). For example, when the image forming apparatus 20 is an A4-model image forming apparatus, the currently targeted setting-value specified button corresponds to the “print” function, and the setting value set for the setting item “sheet feed source” set for the currently targeted setting-value specified button is “A3-size sheet feed cassette”, the client application 28a sets the setting value indicated in the default setting value information 27d for the setting item “sheet feed source”.

When it is determined at S125 that the setting values set for the setting items set for the currently targeted setting-value specified button do not include a setting value not supported by the image forming apparatus 20 or the process at S126 ends, the client application 28a determines whether the setting-value specified buttons included in the operation screen received from the user terminal 30 include a setting-value specified button that has not been targeted yet (S127).

When it is determined at S127 that the setting-value specified buttons included in the operation screen received from the user terminal 30 include a setting-value specified button that has not been targeted yet, the client application 28a executes the process at S122.

When it is determined at S127 that the setting-value specified buttons included in the operation screen received from the user terminal 30 do not include a setting-value specified button that has not been targeted yet, the client application 28a stores various types of information on the operation screen, received from the user terminal 30 and processed during the processes at S124 and S126 as needed, as the operation screen information 27b (S128). When it is determined at S121 that the operation screen received from the user terminal 30 does not includes a setting-value specified button, the client application 28a stores various types of information on the operation screen received from the user terminal 30 as the operation screen information 27b (S128).

After the process at S128, the client application 28a causes the operation screen to be displayed based on the operation screen information 27b (S129) and ends the operation illustrated in FIG. 9.

Next, the operation of the image forming apparatus 20 when a setting-value specified button is pressed on the operation screen is described.

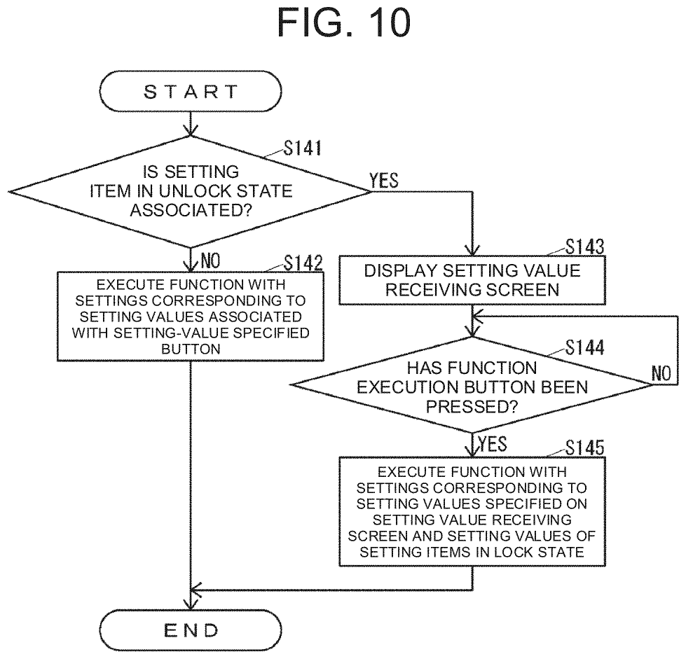

FIG. 10 is a flowchart of the operation of the image forming apparatus 20 when the setting-value specified button is pressed on the operation screen.

The client application 28a of the image forming apparatus 20 executes the operation illustrated in FIG. 10 when a setting-value specified button is pressed on the operation screen via the operating unit 21.

As illustrated in FIG. 10, the client application 28a determines whether the pressed setting-value specified button is associated with a setting item in the unlock state (S141).

When it is determined at S141 that the pressed setting-value specified button is not associated with a setting item in the unlock state, the client application 28a executes the function associated with the setting-value specified button with the settings corresponding to the setting values associated with the setting-value specified button (S142) and ends the operation illustrated in FIG. 10.

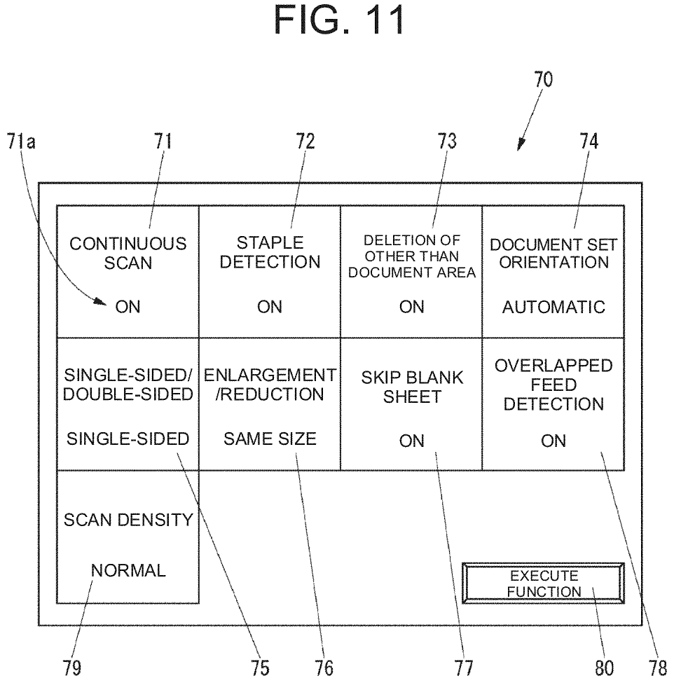

When it is determined at S141 that the pressed setting-value specified button is associated with a setting item in the unlock state, the client application 28a causes the display unit 22 to display a setting value receiving screen 70 (see FIG. 11) for receiving the instruction to change the setting value of the setting item in the unlock state associated with the setting-value specified button (S143).

FIG. 11 is a diagram illustrating an example of the setting value receiving screen 70 displayed during the operation illustrated in FIG. 10.

The setting value receiving screen 70 illustrated in FIG. 11 is a screen for specifying the setting values for the setting-value specified button corresponding to the “scan” function when the setting items of “continuous scan”, “staple detection”, “deletion of other than the document area”, “document set orientation”, “single-sided/double-sided”, “enlargement/reduction”, “skip blank sheet”, “overlapped feed detection” and “scan density” are in an unlock state.

The setting value receiving screen 70 illustrated in FIG. 11 includes: a setting value receiving button 71 for receiving the instruction to change the setting value specified for the setting item “continuous scan”; a setting value receiving button 72 for receiving the instruction to change the setting value specified for the setting item “staple detection”; a setting value receiving button 73 for receiving the instruction to change the setting value specified for the setting item “deletion of other than the document area”; a setting value receiving button 74 for receiving the instruction to change the setting value specified for the setting item “document set orientation”; a setting value receiving button 75 for receiving the instruction to change the setting value specified for the setting item “single-sided/double-sided”; a setting value receiving button 76 for receiving the instruction to change the setting value specified for the setting item “enlargement/reduction”; a setting value receiving button 77 for receiving the instruction to change the setting value specified for the setting item “skip blank sheet”; a setting value receiving button 78 for receiving the instruction to change the setting value specified for the setting item “overlapped feed detection”; a setting value receiving button 79 for receiving the instruction to change the setting value specified for the setting item “scan density”; and a function execution button 80 for performing the function associated with the target setting-value specified button on the setting value receiving screen 70.

The setting value receiving button 71 includes a text 71a indicating a currently specified setting value. When the setting value receiving button 71 is pressed, the client application 28a receives the instruction to change the setting value specified for the setting item “continuous scan” associated with the setting value receiving button 71. Although the setting value receiving button 71 has been described, the setting value receiving buttons 72 to 79 also include the text indicating a currently specified setting value.

The client application 28a arranges the setting value receiving buttons on the setting value receiving screen 70 such that the setting value receiving button on the left side in the columns including the setting value receiving buttons at the identical position in the vertical direction comes on top in the display order indicated on the operation screen information 27b and the setting value receiving button at the right end in the columns of the setting value receiving buttons at an upper position in the vertical direction comes on top in the display order indicated on the operation screen information 27b as compared with the setting value receiving button at the left end in the columns of the setting value receiving buttons at an lower position in the vertical direction. That is, the client application 28a may arrange the setting value receiving buttons on the setting value receiving screen 70 in a user-friendly order. It depends on the client application 28a as to how to arrange the setting value receiving buttons on the setting value receiving screen in accordance with the display order indicated in the operation screen information 27b.

As illustrated in FIG. 10, after the process at S143, the client application 28a determines whether the function execution button 80 has been pressed until it is determined that the function execution button 80 has been pressed (S144).

When it is determined at S144 that the function execution button 80 on the setting value receiving screen 70 has been pressed, the client application 28a executes the function associated with the setting-value specified button with the settings corresponding to the setting values specified on the setting value receiving screen 70 and the setting values of the setting items in the lock state associated with the target setting-value specified button on the setting value receiving screen 70 (S145) and ends the operation illustrated FIG. 10.

As described above, the user terminal 30 acquires the setting items whose setting values are specifiable from a plurality of image forming apparatuses with regard to the function corresponding to the setting-value specified button (S104) and causes the setting items acquired from at least one image forming apparatus to be displayed on the setting value specifying screen (S105); thus, it is possible to prevent the setting value from being specified on the setting value specifying screen for the setting item whose setting value is specifiable in neither of the image forming apparatuses and, as a result, it is possible to improve the convenience of collectively executing the settings for the setting-value specified button for the image forming apparatuses having different setting items whose setting values are specifiable with regard to the function corresponding to the setting-value specified button.

As the user terminal 30 may collectively execute the settings for the setting-value specified button for the image forming apparatuses having different setting items whose setting values are specifiable with regard to the function corresponding to the setting-value specified button, the time required for the settings of the setting-value specified button may be shortened.

The user terminal 30 acquires the setting values that are specifiable for the setting items whose setting values are specifiable from a plurality of image forming apparatuses with regard to the function corresponding to the setting-value specified button (S104) and causes the setting values acquired from at least one image forming apparatus to be displayed on the setting value specifying screen (S105); thus, it is possible to prevent the setting values that are specifiable in neither of the image forming apparatuses from being specified on the setting value specifying screen and, as a result, it is possible to improve the convenience of collectively executing the settings for the setting-value specified button for the image forming apparatuses having different specifiable setting values with regard to the function corresponding to the setting-value specified button.

As the user terminal 30 may collectively execute the settings for the setting-value specified button for the image forming apparatuses having different specifiable setting values with regard to the function corresponding to the setting-value specified button, the time required for the settings of the setting-value specified button may be shortened.

The user terminal 30 acquires, from a plurality of image forming apparatuses, a setting item whose setting value is specifiable and a setting value that is specifiable for the setting item with regard to the function corresponding to the setting-value specified button when the setting-value specified button is set; therefore, the latest setting items and setting values may be acquired from an image forming apparatus even if a setting item and a setting value are added due to, for example, the firmware update to the image forming apparatus. The user terminal 30 may acquire, from a plurality of image forming apparatuses, a setting item whose setting value is specifiable and a setting value that is specifiable for the setting item with regard to the function corresponding to the setting-value specified button at a time other than when the setting-value specified button is set. For example, the user terminal 30 may acquire, from a plurality of image forming apparatuses, a setting item whose setting value is specifiable and a setting value that is specifiable for the setting item with regard to the function corresponding to the setting-value specified button when the setting tool 35a is started up, when the information for identifying a new image forming apparatus is acquired from the image forming apparatus, when the operation-screen editing screen is displayed on the display unit 32, or at any time designated by the user. When the user terminal 30 acquires, from a plurality of image forming apparatuses, a setting item whose setting value is specifiable and a setting value that is specifiable for the setting item with regard to the function corresponding to the setting-value specified button at a time other than when the setting-value specified button is set, the time required for the settings of the setting-value specified button may be shortened.

The image forming apparatus 20 exclusively displays, on the setting value receiving screen, the setting items supported by the image forming apparatus 20 itself among the setting items included in the operation screen received from the user terminal 30 (S124 and S129); therefore, it is possible to prevent the setting value for an unsupported setting item from being improperly specified.

When the image forming apparatus 20 does not support the setting value specified for the setting item included in the operation screen received from the user terminal 30, the setting value is changed to the default setting value of the image forming apparatus 20 itself (S126); therefore, it is possible to prevent the occurrence of an error.

What is claimed is:

1. A setting apparatus that sets an operation screen of electronic apparatuses, wherein
the operation screen includes a setting-value specified button to execute a function in accordance with a previously specified setting value, and
the setting apparatus
acquires, from the electronic apparatuses, a setting item whose setting value is specifiable with regard to a function corresponding to the setting-value specified button, and
displays a setting item acquired from at least one of the electronic apparatuses on a setting value specifying screen for specifying a setting value for the setting-value specified button.

2. The setting apparatus according to claim 1, wherein the setting apparatus
acquires, from the electronic apparatuses, a specifiable setting value for a setting item whose setting value is specifiable with regard to the function corresponding to the setting-value specified button, and
displays the setting value acquired from at least one of the electronic apparatuses on the setting value specifying screen.

3. A computer-readable non-transitory recording medium that stores a setting program executed by a setting apparatus that sets an operation screen of electronic apparatuses, wherein
the operation screen includes a setting-value specified button to execute a function in accordance with a previously specified setting value, and
the setting program
causes the setting apparatus to acquire, from the electronic apparatuses, a setting item whose setting value is specifiable with regard to a function corresponding to the setting-value specified button, and
causes the setting apparatus to display a setting item acquired by the setting apparatus from at least one of the electronic apparatuses, on a setting value specifying screen for specifying a setting value for the setting-value specified button.

4. An electronic apparatus that displays an operation screen, wherein
the operation screen includes a setting-value specified button to execute a function in accordance with a previously specified setting value, and
the electronic apparatus exclusively displays, on a setting value receiving screen for receiving an instruction to change a setting value of a setting item associated with the setting-value specified button, a setting item supported by the electronic apparatus among setting items included in the operation screen received from a setting apparatus that sets the operation screen.

5. A computer-readable non-transitory recording medium that stores an operation screen control program executed by an electronic apparatus that displays an operation screen, wherein
the operation screen includes a setting-value specified button to execute a function in accordance with a previously specified setting value, and
the operation screen control program causes the electronic apparatus to exclusively display, on a setting value receiving screen for receiving an instruction to change a setting value of a setting item associated with the setting-value specified button, a setting item supported by the electronic apparatus among setting items included in the operation screen received by the electronic apparatus from a setting apparatus that sets the operation screen.

6. An electronic apparatus that displays an operation screen, wherein
the operation screen includes a setting-value specified button to execute a function in accordance with a previously specified setting value, and
when the electronic apparatus does not support a setting value specified for a setting item included in the operation screen received from a setting apparatus that sets the operation screen, the electronic apparatus changes the setting value to a default setting value of the electronic apparatus.

7. A computer-readable non-transitory recording medium that stores an operation screen control program executed by an electronic apparatus that displays an operation screen, wherein
the operation screen includes a setting-value specified button to execute a function in accordance with a previously specified setting value, and
when the electronic apparatus does not support a setting value specified for a setting item included in the operation screen received by the electronic apparatus from a setting apparatus that sets the operation screen, the operation screen control program causes the electronic apparatus to change the setting value to a default setting value of the electronic apparatus.

8. An information processing system comprising:
electronic apparatuses that display an operation screen; and
a setting apparatus that sets the operation screen, wherein
the operation screen includes a setting-value specified button to execute a function in accordance with a previously specified setting value, and
the setting apparatus
acquires, from the electronic apparatuses, a setting item whose setting value is specifiable with regard to a function corresponding to the setting-value specified button, and
displays a setting item acquired from at least one of the electronic apparatuses on a setting value specifying screen for specifying a setting value for the setting-value specified button.
